(19) United States
(12) Patent Application Publication
(10) Pub. No.: US 2005/0262702 A1
(43) Pub. Date: Dec. 1, 2005

(54) Construction saw blade

(76) Inventor: John E. Hawthorn, Red Bank, NJ (US)

Correspondence Address: Charles I. Brodsky, Esq., 2 Bucks Lane, Marlboro, NJ, 07746, US

(21) Appl. No.: 10/856,479

(22) Filed: Jun. 1, 2004

(51) Int. Cl. B27B 21/00

(52) U.S. Cl. 30/166.3; 30/355

(57) ABSTRACT

A construction saw blade having pluralities of cutting teeth along upper and lower edge surfaces thereof, an aperture transversely extending through the blade adjacent its rearwardly facing back end of a configuration and dimension to receive a fastener to removably secure the blade to a reciprocating saw for use, and wherein each plurality of cutting teeth include rake angles for cutting substantially only on a pull stroke of the reciprocating saw.

### CROSS-REFERENCE TO RELATED APPLICATIONS

None

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not applicable.

### BACKGROUND OF THE INVENTION

1. Field of the Invention

The present invention relates to the home remodeling and demolition industry, in general, and to the construction of a saw blade improvement for use therein, in particular.

2. Description of the Related Art

As is well known and understood, one of the most widely used tools in the home remodeling and demolition industries is a reciprocating saw. Designed for cutting on the “pull-stroke” of the reciprocating saw, such blades are often used for cutting wood, lath and metal pipes. Usually manufactured of thin flexible steel, any cutting of “metal” with a blade designed for “wood” effectively destroys the teeth. Conversely, cutting “wood” with a blade designed for cutting “metal”, takes an inordinate amount of time. Moreover, situations often arise where use of the reciprocating saw at one angle becomes difficult at a second angle where the cutting surface is not optimally positioned to work at. To deal with these situations typically requires the contractor to stop work, to turn off the electrically operating or battery powered reciprocating saw, and to either change blades to the one best suited for the job at hand, or to just flip the blade over to a better angle for use. Besides being inconvenient and an unnecessary waste of time, this becomes all the more a matter of concern when the change of blades, or the flipping over of them requires the contractor to come down a ladder before doing whatever is necessary in making the changeover, and then having to climb back up the ladder to continue the work. Obviously, it would be desirable if all these intermediate steps could somehow be eliminated.

### OBJECTS OF THE INVENTION

It is an object of the present invention, therefore, to provide a construction saw blade for a reciprocating saw which can be used whether the angle of cut required be convenient or not.

It is also an object of the invention to provide such a blade capable of cutting both “wood” and “metal”.

It is another object of the invention to provide a construction saw blade for a reciprocating saw which enables a contractor to cut different types of materials being confronted on a job without having to change a blade because of a needed change in the materials confronted or because of the angle of their presentation.

### SUMMARY OF THE INVENTION

As will become clear from the following description, a construction saw blade according to the invention is defined by an upper edge surface, a lower edge surface, a forwardly facing front end, and a rearwardly facing back end. Such blade will also be seen to have a first plurality of cutting teeth along the upper edge surface, a second plurality of cutting teeth along the lower edge surface, and an aperture transversely extending through the blade adjacent to the rearwardly facing back end. Such aperture, moreover, is of a configuration and dimension so as to receive a fastening means in removably securing the construction saw blade to a reciprocating saw for use. In accordance with the teachings of the invention, each of the first and second plurality of cutting teeth include rake angles for cutting substantially only on a pull-stroke of the reciprocating saw.

In one embodiment of the invention, the first plurality of teeth exhibit an inverted profile of rake angles substantially identical to the second plurality of teeth. As will be appreciated, whether the rake angles of the two pluralities exhibit profiles for cutting “wood” or cutting “metal”, this construction allows the contractor to utilize the reciprocating saw without having to flip the blade over from one angle of use to another where the positioning of the work to be done varies from site to site.

In accordance with a second embodiment of the invention, the two pluralities of teeth exhibit different profiles of rake angles—for one to be employed for cutting “wood”, for example, and for the other to be used for cutting “metal”. This will be seen quite useful so that a contractor does not have to change blades of the reciprocating saw when confronted with different materials to be cut in remodeling or demolishing the area worked on.

In accordance with yet a further embodiment of the invention, at least one of the first and second pluralities of cutting teeth may include first and second individual lengths of teeth, with each length being of different rake angle. In this manner, an extended use of the construction saw blade could be had by having, for example, lengths of “wood” cutting and “metal” cutting teeth on each of the upper edge surface of the blade and/or on the lower edge surface. As will be appreciated by those skilled in the art, this construction would be quite beneficial where the lengths of cut to be made at the site are relatively short.

### BRIEF DESCRIPTION OF THE DRAWINGS

These and other features of the present invention will be more clearly understood from a consideration of the following description, taken in connection with the accompanying drawings, in which:

FIGS. 1-4 are pictorial views of construction saw blades according to the invention in which pluralities of cutting teeth are present along both the upper edge surface and the lower edge surface of a blade to be removably secured to a reciprocating saw for use.

### DETAILED DESCRIPTION OF THE INVENTION

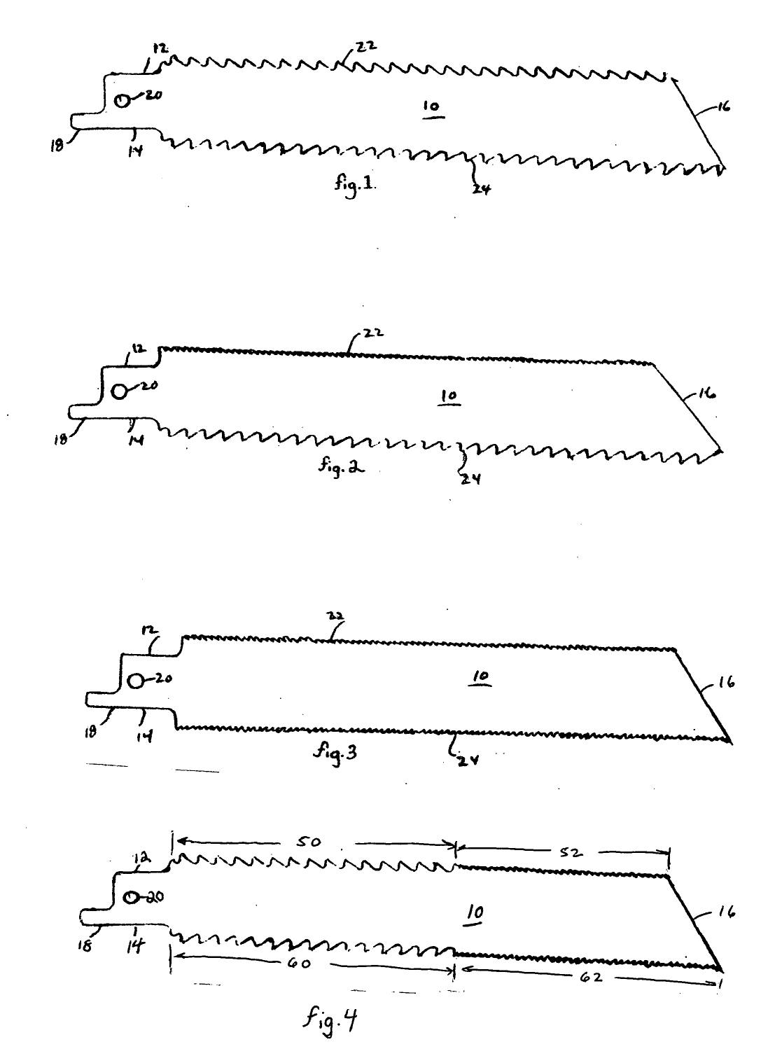

Each of FIGS. 1-4 show a construction saw blade 10 defined by an upper edge surface 12, a lower edge surface 14, a forwardly facing front end 16, and a rearwardly facing back end 18. An aperture 20 is provided, transversely extending through the blade 10 adjacent its rearwardly facing back end 18, of a configuration and dimension to receive a fastening means to removably secure the blade 10 to a reciprocating saw for use. Such fastening means may include any type of conventionally employed clamping device, such as may be tightened by screwdriver or Allen wrench.

In accordance with the invention, the blade 10 is constructed to have a first plurality of cutting teeth 22 along the upper edge surface 12, and a second plurality of cutting teeth 24 along the lower edge surface 14. As illustrated in FIGS. 1-4, each of the first and second pluralities of teeth 22, 24 include rake angles for cutting substantially only a pull-stroke of the reciprocating saw.

In particular, FIGS. 1 and 3 illustrate the pluralities of teeth 22 and 24 exhibiting an inverted profile of rake angles which are substantially identical one to another. As will be appreciated, the blade of FIG. 1 is particularly suited, because of the configuration of the teeth, for cutting wood. In FIG. 3, on the other hand, the teeth exhibit profiles of rake angles particularly suited for cutting metal. With either the blade 10 of FIG. 1 or that of FIG. 3, the contractor or other user of the reciprocating saw will then be able to cut the job at hand without having to face the necessity of flipping the blade over to a better angle for use as dictated by the spatial relationship between the user and the area to be cut.

In the construction of FIG. 2, on the other hand, the teeth 22 at the upper edge 12 will be seen to exhibit an inverted profile of rake angle different from that of the plurality of teeth 24 on the lower edge surface 14. As will be appreciated, the plurality of teeth 22 is particularly suited for cutting “metal”, while the plurality of teeth 24 is particularly suited for cutting “wood”. This construction enables the contractor or user to cut both wood and metal with the same reciprocating saw blade, without first having the necessity of changing blades when confronted with different material—as with the prior art when confronting wood on the one hand, and then nails or metal pipe on the other hand.

Recognizing that some required cuts are only of a small distance and that the construction saw blade of the invention is intended to be of the same 12 inch length or so of those blades presently employed in the home remodeling and demolition industry, the construction saw blade of FIG. 4 is one in which first and second individual lengths of teeth may be utilized on each of the upper and lower edge surfaces 12, 14, with each length of different rake angle. Thus, in FIG. 4, the upper edge surface 12 incorporates one length 50 of wood cutting teeth followed by a second length 52 of metal cutting teeth; the lower edge surface 14 then indicates a second length 60 of wood cutting teeth and a second length of metal cutting teeth 62. As will be appreciated, the positioning of the lengths 50 and 52, as well as the lengths 60 and 62 may be reversed where desired, and be longer or shorter as the case may be.

In accordance with the teachings of the present invention, however, the construction saw blade of the invention will continue to be usable with a reciprocating saw by fastening the blade 10 to the saw by means of a fastener coupling with the aperture 20. At the same time, it will be appreciated that the profile of the rake angles employed continue to allow the cutting of “wood” or “metal” (or of any other material for that matter), simply on the pull-stroke of the saw as characterizes present reciprocating saw designs. As with those blades that are conventionally used nowadays, the construction saw blade of the present invention may be manufactured of a stamped steel composition, as a thin flexible steel.

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the invention.

1. A construction saw blade comprising:
a blade defined by an upper edge surface, a lower edge surface, a forwardly facing front end, and a rearwardly facing back end;
said blade also having a first plurality of cutting teeth along said upper edge surface, a second plurality of cutting teeth along said lower edge surface, and an aperture transversely extending through said blade adjacent said rearwardly facing back end;
wherein said aperture is of configuration and dimension to receive a fastening means to removably secure said blade to a reciprocating saw for use; and
wherein each of said first and second plurality of cutting teeth include rake angles for cutting substantially only on a pull-stroke of said reciprocating saw.

2. The construction saw blade of claim 1 wherein said first plurality of teeth exhibits an inverted profile of rake angles substantially identical to that of said second plurality of teeth.

3. The construction saw blade of claim 1 wherein said first plurality of teeth exhibits an inverted profile of rake angles different from that of said second plurality of teeth.

4. The construction saw blade of claim 2 wherein each of said first and second pluralities of teeth exhibit profiles of rake angles for cutting wood.

5. The construction saw blade of claim 2 wherein each of said first and second pluralities of teeth exhibit profiles of rake angles for cutting metal.

6. The construction saw blade of claim 3 wherein one of said first and second pluralities of teeth exhibits a profile of rake angles for cutting wood and wherein the other of said first and second pluralities of teeth exhibits a profile of rake angles for cutting metal.

7. The construction saw blade of claim 1 wherein said blade is manufactured of a stamped steel composition.

8. The construction saw blade of claim 1 wherein said blade is manufactured of thin flexible steel.

9. The construction saw blade of claim 1 wherein at least one of said first and second pluralities of cutting teeth include first and second individual lengths of teeth, each length being of different rake angle.
